(19) United States
(12) Patent Application Publication
(10) Pub. No.: US 2013/0292351 A1
(43) Pub. Date: Nov. 7, 2013

(54) MODULAR SHELVING AND DISPLAY SYSTEM

(71) Applicant: Jordan W. Wyatt, Astoria, NY (US)

(72) Inventor: Jordan W. Wyatt, Astoria, NY (US)

(21) Appl. No.: 13/461,843

(22) Filed: May 2, 2012

(51) Int. Cl. A47F 5/10; B23P 11/00; A47B 47/04; A47B 47/00; A47B 47/02

(52) U.S. Cl. 211/188; 29/428

(57) ABSTRACT

A modular shelving and display system includes a plurality of panels connected together by a plurality of fasteners. Each of the panels has a plurality of recesses provided therein, such as one at each of the corners thereof. Each of the fasteners includes a plurality of outwardly extending arms. The arms of the fasteners are inserted within the recesses of the panels to form the modular shelving and display system.

### BACKGROUND OF THE INVENTION

This invention relates in general to structures for supporting and displaying articles. In particularly, this invention relates to an improved modular shelving and display system that is simple and inexpensive in structure and that can be assembled without the use of tools or conventional fasteners.

A wide variety of shelving and display systems are known in the art. Many of these known shelving and display systems are composed of many parts, are often limited to a single configuration, and require the use of tools and conventional fasteners, such as nails and screws. As a result, many known shelving and display systems are relatively complicated and expensive in structure and relatively time consuming to assemble. Thus, it would be desirable to provide an improved modular shelving and display system that is simple and inexpensive in structure and that can be assembled without the use of tools or conventional fasteners.

### SUMMARY OF THE INVENTION

This invention relates to an improved modular shelving and display system that is simple and inexpensive in structure and that can be assembled without the use of tools or conventional fasteners. The modular shelving and display system includes a plurality of panels connected together by a plurality of fasteners. Each of the panels has a plurality of recesses provided therein, such as one at each of the corners thereof. Each of the fasteners includes a plurality of outwardly extending arms. The arms of the fasteners are inserted within the recesses of the panels to form the modular shelving and display system.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a perspective view of a modular shelving and display system in accordance with this invention.

FIG. 2 is an enlarged perspective view of a portion of the modular shelving and display system illustrated in FIG. 1.

FIG. 3 is a further enlarged elevational view of one of a plurality of panels that is used in the modular shelving and display system illustrated in FIGS. 1 and 2.

FIG. 4 is a still further enlarged elevational view of one of the corners of the panel illustrated in FIG. 3.

FIG. 5 is a perspective view of the corner of the panel illustrated in FIG. 4.

FIG. 6 is an enlarged perspective view of one of a plurality of fasteners that is used in the modular shelving and display system illustrated in FIGS. 1 and 2.

FIG. 7 an end elevational view of the fastener illustrated in FIG. 6.

FIG. 8 is a side elevational view of the fastener illustrated in FIGS. 6 and 7.

### DETAILED DESCRIPTION OF THE PREFERRED EMBODIMENT

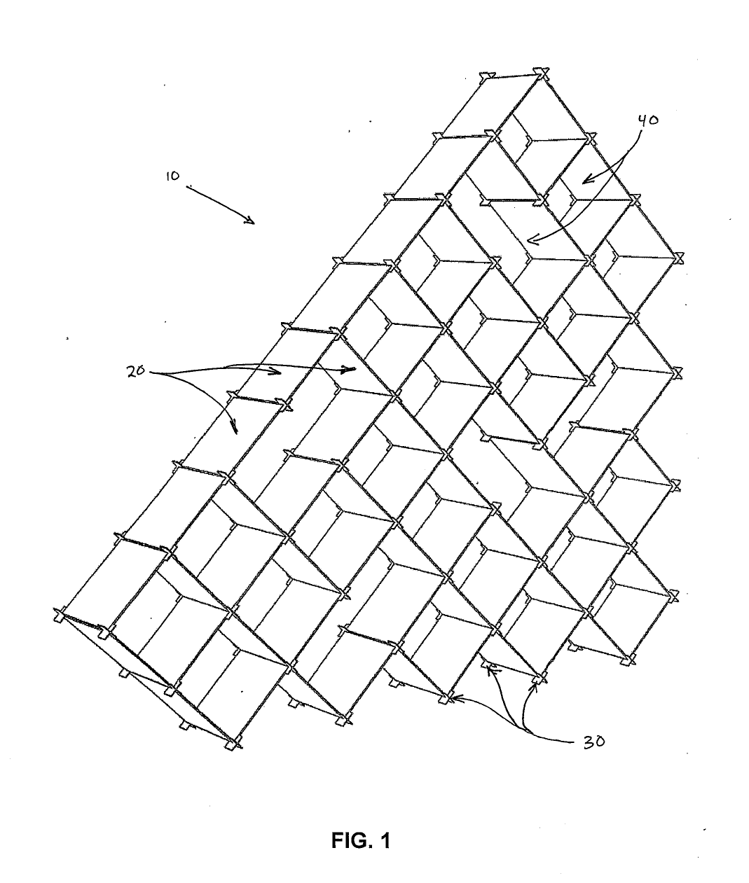

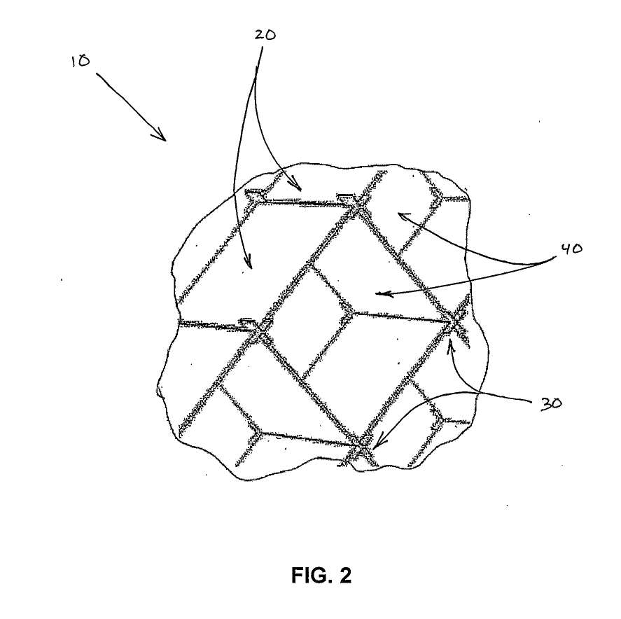

Referring now to the drawings, there is illustrated in FIGS. 1 and 2 a modular shelving and display system, indicated generally at 10, in accordance with this invention. The modular shelving and display system 10 includes a plurality of panels, each indicated generally at 20, connected together by a plurality of fasteners, each indicated generally at 30. When the panels 20 and the fasteners 30 of the modular shelving and display system 10 are assembled in the manner described in detail below, a plurality of storage and display chambers, indicated generally at 40, are defined within the modular shelving and display system 10. However, although this invention will be described and illustrated in the context of the illustrated modular shelving and display system 10, it will be appreciated that the structure of this invention can be used for other applications. For example, this invention could be applied on physically larger scale for other modular structural applications including scaffolding, pavilions, stages, bridges, and the like.

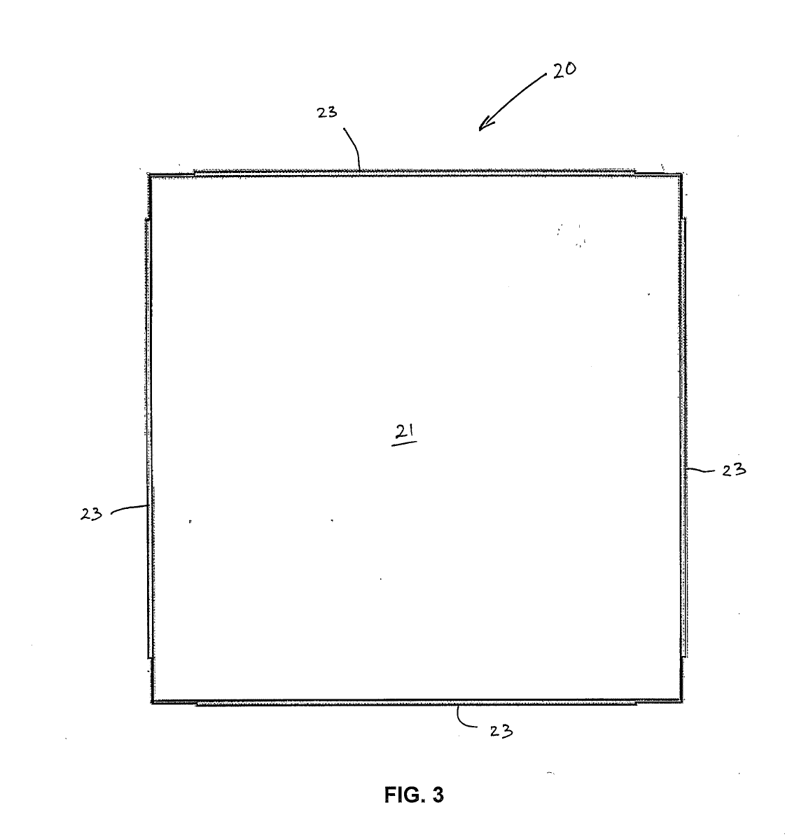

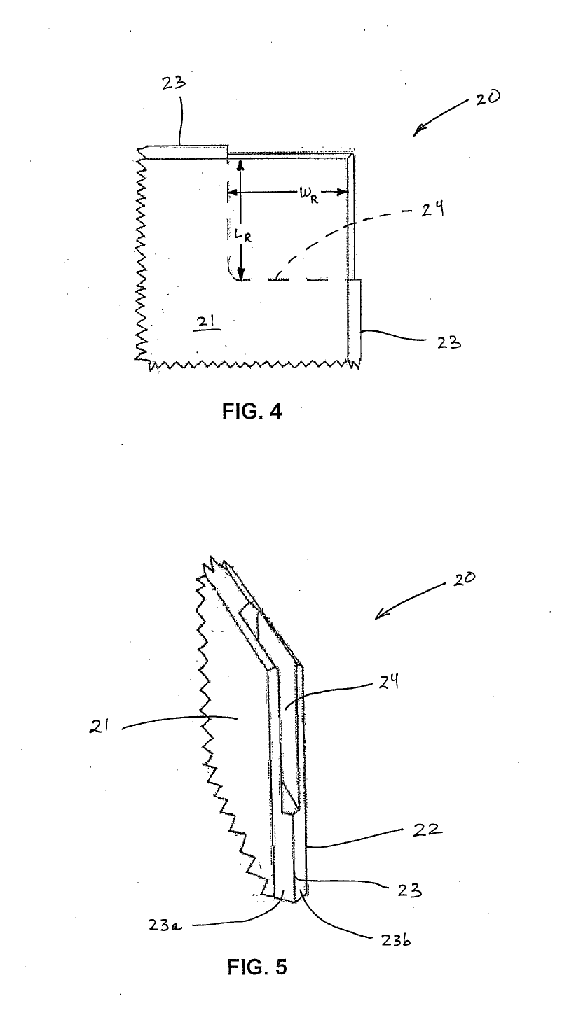

FIGS. 3, 4, and 5 illustrate the structure of one of the plurality of panels 20 used in the modular shelving and display system 10. In the illustrated embodiment, each of the plurality of panels 20 has the same size and shape. However, it will be appreciated that some or all of the plurality of panels 20 may be differently sized and shaped as desired. The illustrated panel 20 is generally flat and planar in shape, including a first surface 21, a second surface 22, and a plurality of sides 23 that extend about the periphery of the panel 20 between the first and second surfaces 21 and 22. In the illustrated embodiment, the first and second surfaces 21 and 22 of the panel 20 extend generally parallel to one another (although such is not required) and are spaced apart from one another by a thickness that is relatively small in comparison to their lengths and widths.

As best shown in FIG. 5, each of the sides 23 of the illustrated panel 20 has a generally triangular cross-sectional shape that is defined tapered surfaces 23a and 23b that extend respectively from the first and second surfaces 22 and 23 thereof toward one another. However, the sides 23 of the panel 20 may be formed having any desired shape or combination of shapes. For example, some or all of the sides 23 of the panel 20 may extend perpendicularly between the first and second surfaces 21 and 22 of the panel 20.

The illustrated panel 20 is shaped in the form of a square having four linearly-extending sides 23 that all have the same length and that extend at right angles relative to one another. However, this invention contemplates that some or all of the panels 20 of the modular shelving and display system 10 may be formed having a greater or lesser number of sides 23 than as illustrated. Also, this invention contemplates that some or all of the sides 23 of any or all of the panels 20 may either extend non-linearly, have differing lengths, and extend at differing angles relative to one another.

As best shown in FIG. 5, the illustrated panel 20 has a plurality of recesses 24 provided therein. In the illustrated embodiment, four of such recesses 24 are provided in the panel 20, one at each of the four corners defined between adjacent ones of the four sides 23 thereof. However, this invention contemplates that any desired number of recesses 24 may be provided at any desired locations on the panel 24. Each of the illustrated recesses 24 is generally square in shape, having a length L_{R} that is approximately the same as a width W_{R}. A curved internal corner is provided in each of the illustrated recesses 24, although such is not required. Each of the recesses 24 defines a thickness that is measured in the direction between the first and second surfaces 21 and 22 of the panel 20. All of the illustrated recesses 24 have the same shape. However, this invention contemplates that the recesses 24 may be formed having any desired shape or combination of shapes. The purposes for the recesses 24 will be explained below.

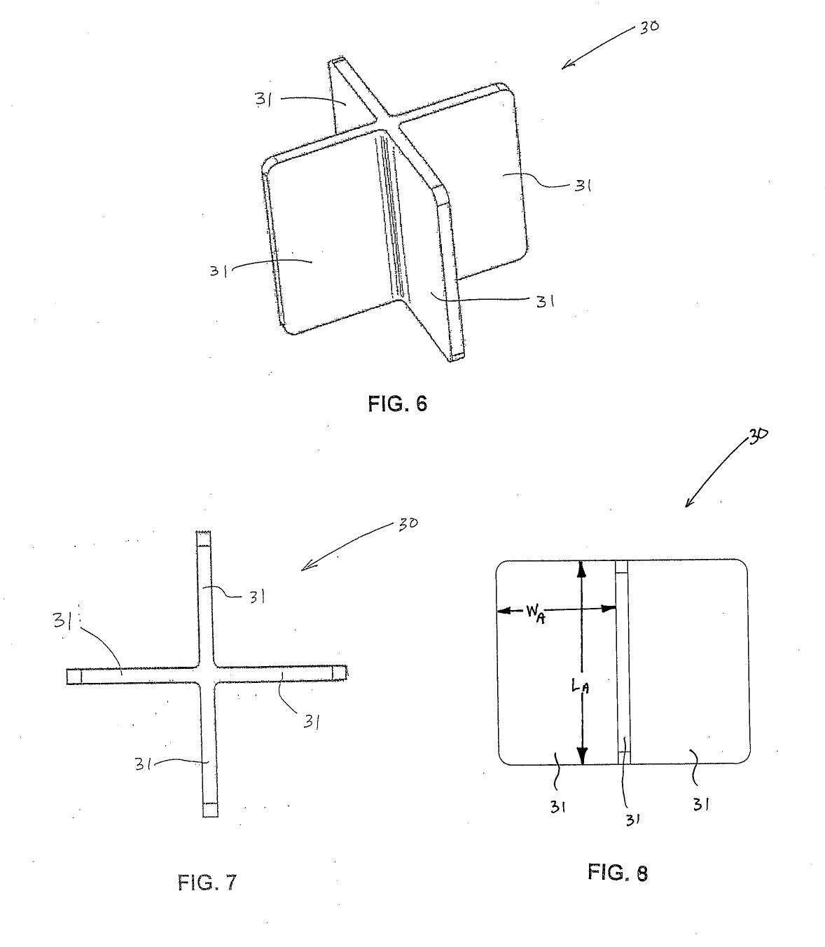

FIGS. 6, 7, and 8 illustrate the structure of one of the fasteners 30 used in the modular shelving and display system 10. As shown therein, the illustrated fastener 30 has four arms 31 that extend outwardly at right angles relative to one another. However, this invention contemplates that some or all of the fasteners 30 may have a greater or lesser number of arms 31 than as illustrated. Also, this invention contemplates that some or all of the arms 31 may extend at differing angles relative to one another. In the illustrated embodiment, each of the arms 31 of the fastener 30 is generally flat and planar in shape and defines a thickness. All of the illustrated arms 31 have the same shape and thickness. However, this invention contemplates that the arms 31 of the fastener 30 may have any desired shape or combination of shapes and/or thicknesses. Each of the illustrated arms 31 is generally rectangular in shape, having a length L_{A} that is larger than a width W_{A}. However, the lengths and widths of some or all of the recesses 24 and the arms 31 can be varied as desired.

To assemble the modular shelving and display system 10, the arms 31 of the fasteners 30 are inserted within the recesses 24 provided in the panels 20 as shown in FIGS. 1 and 2, so as to connect the panels 20 together. Preferably, the arms 31 of the fasteners 30 and the recesses 24 provided in the panels 20 are sized and shaped in such a manner that the arms 31 of the fasteners 30 fit snugly within the recesses 24 provided in the panels 20 when inserted therein. Thus, the thicknesses of the illustrated arms 31 of the fasteners 30 are preferably approximately the same as the thicknesses of the associated recesses 24 provided in the panels 20.

In the illustrated embodiment, the lengths L_{A} of each of the arms 31 of the fasteners 30 are slightly larger than the lengths L_{R} of each of the recesses 24 of the plate 20. As a result, portions of the arms 31 of the fasteners 30 protrude slightly from the sides 23 of the panels 20, as clearly shown in FIGS. 1 and 2. Such relative sizing of the lengths of the arms 31 and the recesses 24 can facilitate the insertion and removal of the fasteners 30 into and out of the panels 20 during assembly and disassembly. However, if desired, the lengths L_{A} of each of the arms 31 of the fasteners 30 may be equal to or less than the lengths L_{R} of each of the recesses 24 of the plate 20 such that portions of the arms 31 of the fasteners 30 do not protrude from the sides 23 of the panels 20.

On the other hand, the widths W_{A} of each of the arms 31 of the fasteners 30 are approximately equal to the widths W_{R} of each of the recesses 24 of the plate 20. Such relative sizing of the widths of the arms 31 and the recesses 24 can insure that the sides 23 of the panels 20 abut one another following assembly, as also clearly shown in FIGS. 1 and 2. However, if desired, the widths W_{A} of each of the arms 31 of the fasteners 30 may be greater or less than the widths W_{R} of each of the recesses 24 of the plate 20.

Each of the illustrated display chambers 40 provided in the modular shelving and display system 10 of FIGS. 1 and 2 has a depth that is equal to the depth of a single one of the panels 20. In some instances, however, it may be desirable to provide display chambers 40 having a depth that is equal to the depth of two or more of the panels 20. To accomplish this, the lengths L_{A} of each of the arms 31 of the fasteners 30 may be formed significantly larger than the lengths L_{R} of each of the recesses 24 of the plate 20. In such an instance, additional panels 20 and fasteners 30 may be assembled into a second layer for the modular shelving and display system 10 that is connected to the first layer illustrated in FIGS. 1 and 2.

The panels 20 may be formed from any desired material or combination of materials. Preferably, however, each of the panels 20 is formed from a material that is relatively rigid and lightweight. For example, the panels 20 may be formed from aluminum or other metals, wood, or plastic. Similarly, the fasteners 30 may be formed from any desired material or combination of materials. Preferably, however, each of the fasteners 30 is formed from a material that is relatively rigid and lightweight. For example, the fasteners 30 may also be formed from aluminum or other metals, wood, or plastic.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A shelving system comprising:
a plurality of panels, each of the plurality of panels having a plurality of recesses provided therein; and
a plurality of fasteners, each of the plurality of fasteners having a plurality of arms;
wherein the arms of the fasteners extend respectively within the recesses of the panels to connect the plurality of panels together and define a shelving system.

2. The shelving system defined in claim 1 wherein each of the plurality of panels has a first surface, a second surface, a plurality of sides, and a plurality of corners defined between adjacent ones of the plurality of sides.

3. The shelving system defined in claim 2 wherein each of the plurality of panels includes four linearly-extending sides having the same length and extending at right angles relative to one another.

4. The shelving system defined in claim 2 wherein each of the plurality of sides is triangular in cross-sectional shape, having tapered portions that respectively extend from the first and second surfaces.

5. The shelving system defined in claim 2 wherein the first and second surfaces of each of the each of the plurality of panels are generally planar and extend generally parallel to one another.

6. The shelving system defined in claim 2 wherein each of the corners of each of the plurality of panels has a recess provided therein.

7. The shelving system defined in claim 1 wherein each of the recesses defines a thickness, and wherein each of the arms of the fasteners defines a thickness that is proximately the same as the thicknesses of the recesses.

8. The shelving system defined in claim 1 wherein each of the plurality of recesses has the same shape.

9. The shelving system defined in claim 1 wherein each of the plurality of panels is formed from a rigid and lightweight material.

10. The shelving system defined in claim 1 wherein each of the plurality of panels is formed from metal, wood, plastic, or any combination thereof.

11. The shelving system defined in claim 1 wherein each of the plurality of fasteners has four arms that extend outwardly at right angles relative to one another.

12. The shelving system defined in claim 11 wherein each of the four arms has the same shape.

13. The shelving system defined in claim 1 wherein each of the plurality of fasteners is formed from a rigid and lightweight material.

14. The shelving system defined in claim 1 wherein each of the plurality of fasteners is formed from metal, wood, plastic or any combination thereof.

15. A method of manufacturing a shelving system comprising the steps of:
(a) providing a plurality of panels, each of the plurality of panels having a plurality of recesses provided therein;
(b) providing a plurality of fasteners, each of the plurality of fasteners having a plurality of arms;
(c) inserting each of the arms of the fasteners within as associated one of the recesses of the panels to connect the plurality of panels together and define a shelving system.
